(19) United States
(12) Patent Application Publication
(10) Pub. No.: US 2025/0218083 A1
(43) Pub. Date: Jul. 3, 2025

(54) Systems and methods for creating editable documents

(71) Applicant: Canva Pty Ltd, Surry Hills (AU)

(72) Inventors: Kerry Halupka, Kensington (AU); Danial Khosravi Bachehmir, Sydney (AU); Velislava Petrova Yanchina, Byron Bay (AU); Robert Fraser Pennefather, Sydney (AU); Etienne Jean Gautier, Sydney (AU)

(73) Assignee: Canva Pty Ltd, Surry Hills (AU)

(21) Appl. No.: 19/005,753

(22) Filed: Dec. 30, 2024

(30) Foreign Application Priority Data
Jan. 3, 2024 (AU) 2024200025

(51) Int. Cl. G06T 11/60; G06F 40/109; G06F 40/166; G06T 5/77; G06T 7/90; G06V 10/762; G06V 10/764; G06V 30/10

(52) U.S. Cl. CPC G06T 11/60; G06F 40/109; G06F 40/166; G06T 5/77; G06T 7/90; G06V 10/762; G06V 10/764; G06V 30/10

(57) ABSTRACT

Optical character recognition data for an image is used to generate a text box. The text box is formed to include text that has a colour and font determined based on analysis of the image. The colour may be determined using k-means clustering and the font determined using a trained image classification model. The text box may be located over the image at a location corresponding to the detected text in the image. The image may be inpainted at the location of the text box to remove the detected text from the image.

### CROSS-REFERENCE TO RELATED APPLICATION

This application is a U.S. Non-Provisional Application that claims priority to Australian Patent Application No. 2024200025, filed Jan. 3, 2024, which is hereby incorporated by reference in its entirety.

### TECHNICAL FIELD

Certain aspects of the present disclosure are directed to systems and methods for creating editable documents.

### BACKGROUND

Various devices for creating image documents exist. One example is a camera to generate digital photographs. Another example is a computer application that allows a user of the application to create a document incorporating a design and save, print or publish the design as an image document. A further example is a trained machine learning algorithm, which might generate an image document based on a prompt.

An image document may not be editable or may only be editable with specific image editing applications. If the image document contains text, optical character recognition may be applied to the image document. The resulting document contains the identified text, which may be searchable and editable as text, without a need to resort to amending the image document.

### SUMMARY

Described herein is a computer implemented method including, for image data defining a first image and associated text data, the associated text data including optical character recognition (OCR) data formed based on the first image determining, based on the first image, at least one of a predicted colour and a predicted font of text defined by the OCR data, and forming, based on the OCR data and the at least one of a predicted colour and a predicted font, at least one text box, each text box comprising the text defined by the OCR data. The text box has attributes including a text colour that is or is associated with the predicted colour, or a text font that is or is associated with the predicted font, or a text colour that is or is associated with the predicted colour and a text font that is or is associated with the predicted font. The method further includes forming a second image based on the first image by inpainting the first image, including inpainting an area of the first image corresponding to said text defined by the OCR data, and locating the at least one text box on the second image.

In some embodiments the OCR data includes bounding boxes. Each bounding box may be associated with a group of glyphs, for example a group of glyphs defining a word or a line. Embodiments of the present invention utilise such bounding boxes.

Accordingly, a computer implemented is described for image data defining a first image and associated text data, the associated text data including optical character recognition (OCR) data defining a plurality of glyphs in the first image and data defining a first bounding box for a group of glyphs within the plurality of glyphs, wherein the first bounding box is one of one or more bounding boxes for groups of glyphs within the plurality of glyphs. The method includes determining, based on a portion of the first image within the first bounding box, at least one of a predicted colour and a predicted font of the at least one group of glyphs, and forming, based on the OCR data and the at least one of a predicted colour and a predicted font, at least one text box for the first bounding box, each text box comprising text defined by the group of glyphs. The text has attributes including a text colour that is or is associated with the predicted colour, or a text font that is or is associated with the predicted font, or a text colour that is or is associated with the predicted colour and a text font that is or is associated with the predicted font. The method includes forming a second image based on the first image by inpainting the first image, including inpainting an area of the first image corresponding to the first bounding box and locating the at least one text box on the second image.

Also described is a computer implemented method including determining a likely font for a plurality of groups of glyphs in an image, the determining including applying to the image data an image classification model trained to identify at least one likely font of the glyphs, and forming a first editable text box based on OCR data for the image, the first editable text box including text corresponding to some, but not all of the plurality of groups glyphs, based at least in part on determinations of whether or not the determined likely font of the respective groups is the same.

Also described is a computer implemented method including determining a likely colour for a plurality of groups of glyphs in an image, the determining including determining the first and second-most dominant colours in the image the location of each group of glyphs and identifying one of the first and second-most dominant colours as the determined likely colour, and forming a first editable text box based on OCR data for the image, the first editable text box including text corresponding to some, but not all of the plurality of groups glyphs, based at least in part on determinations of whether or not the determined likely colour of the respective groups is the same.

Other computer-implemented methods will be apparent from the following detailed description and the accompanying figures, as well as systems for implementing the methods.

### BRIEF DESCRIPTION OF THE DRAWINGS

FIGS. 1A-B depict example designs and FIG. 1C depicts lines and paragraphs associated with the design of FIG. 1B.

FIG. 2 is a diagram depicting a computing environment in which various features of the present disclosure may be implemented.

FIG. 3 is a block diagram of a computer processing system configurable to perform various features of the present disclosure.

FIG. 4 depicts an example design user interface.

FIG. 5 depicts processes performed in a method for creating an image with text editable by a text editor.

FIG. 6 depicts operations performed in a method for predicting or estimating a font colour for identified text in an OCR image.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

As discussed above, computer applications for use in creating documents incorporating designs are known. Such applications will typically provide various functions that can be used in creating and editing designs. For example, such design editing applications may provide users with the ability to edit an existing design by deleting elements of the existing design that are not wanted; editing elements of the existing design that are of use, but not in their original form or location within the design; and adding new elements. Where there are design elements in the design that are in the form of text, the design editing application may include a text editor, which allows for the text to be edited, for example through amendment of the letters, numbers or characters in the text, and for the properties of the text to be edited, for example through amendment of the font style, type, size, position/justification, whether the text is underlined or in bold, whether the text includes effects like strike-through or shadowing and so forth.

Typically a design editing application is configured to create documents in one or more specific formats. The design editing application includes functionality to open a document saved in of the specific formats, make edits to the document and save the edited document into the same format or into another one of the specific formats. The design editing application may have some functionality to edit documents that are image files or to edit images within the document, but often this functionality is limited.

The present disclosure provides techniques for processing an image document to create a modified image document with editable text within it. In particular, the modified image document preserves at least some or all of the image and includes editable text within the image. The editable text may corresponds to or estimate text in the image document. For example, the editable text may be edited using typical text editing functions of a design editing application, like amendment to the letters, numbers or characters and amendment to the properties of the text. This form of editing is typically much easier and more efficient than image editing techniques using an image editor of an image editing application to achieve a similar result.

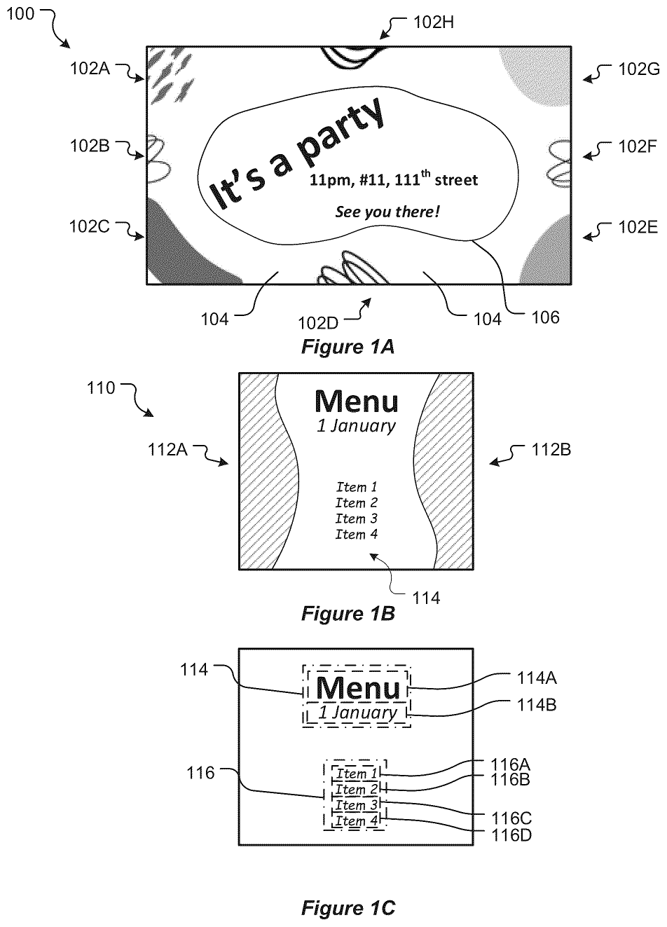

In order to illustrate this, consider a scenario in which an image document is received that has a design 100 as shown in FIG. 1A or a design 110 as shown in FIG. 1B.

The design 100 is a party invitation design that includes various decorations 102A-102H, a solid background fill 104 of a particular colour and an internal closed curve element 106 that includes within it text of “It's a party”, “1 pm, #11, 111^{th} street”, and “See you there!”. A person may wish to use the design 100 for another event or for their own event and to do so requires different text. The design 110 is a menu design that includes two decorations 112A and 112B and a set of text 114 reading “Menu”, “1 January”, “Item 1”, “Item 2”, “Item 3”, and “Item 4”. Similarly, a person may wish to use design 100 for another day, so wish to edit the date and the items in the menu.

As the designs 100, 110 are in respective image documents it would be cumbersome to edit the text of each using an image editor. The present disclosure relates to various functions that create, or are usable for the creation of, a modified image document that incorporates at least part of the design 100 or design 110 and in which the text is editable using text editing operations of a text editor, as opposed to image editing operations of an image editor. The present disclosure does not however exclude the option to use an image editor, in addition to the use of a text editor. For example editing operations of text may be performed using a text editor and then refined using an image editor.

The functions disclosed herein are described in the context of a design platform that is configured to facilitate various operations concerned with digital image documents. In the context of the present disclosure, these operations relevantly include processing digital image documents to identify characteristics of the document and utilising the identified characteristics to create a modified image document incorporating text editable using a text editor.

A design platform may take various forms. In the embodiments described herein, the design platform is described as a stand-alone computer processing system (e.g. a single application or set of applications that run on a user's computer processing system and perform the techniques described herein without requiring server-side operations). The techniques described herein can, however, be performed (or be adapted to be performed) by a client-server type computer processing system (e.g. one or more client applications on a user's computer processing system and one or more server applications on a provider's computer processing system that interoperate to perform the described techniques). It will be appreciated that the combination of two (or more) computer processing systems operating in a client-server arrangement may be viewed as a computer processing system made of two (or more) subcomponents that are the client side and server side computer processing systems.

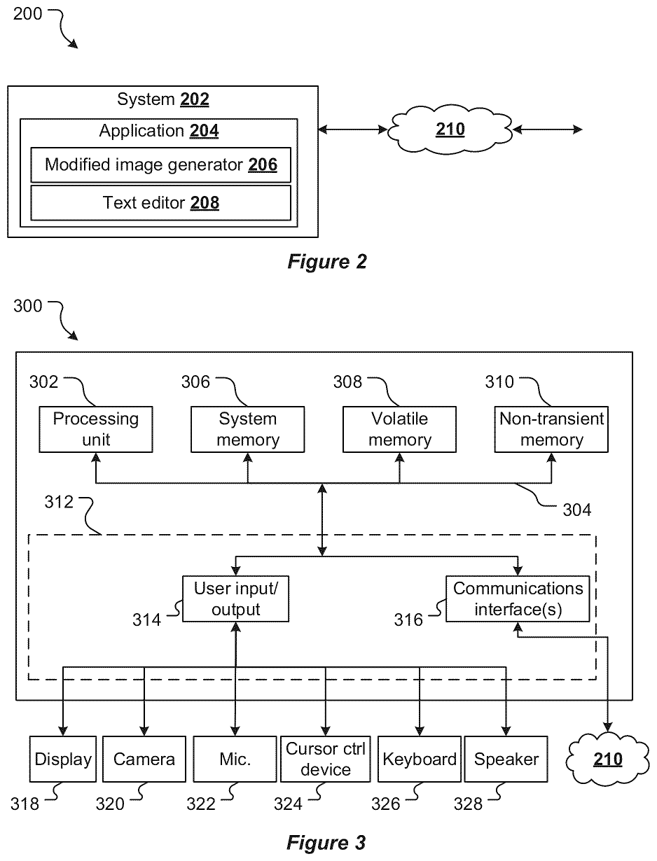

FIG. 2 depicts a system 202 that is configured to perform the various functions described herein. The system 202 may be a suitable type of computer processing system, for example a desktop computer, a laptop computer, a tablet device, a smart phone device, or an alternative computer processing system.

The system 202 is configured to perform the functions described herein by execution computer readable instructions that are stored in a storage device (such as non-transient or non-transitory memory 310 described below) and executed by a processing unit of the system 202 (such as processing unit 302 described below). For convenience the set of computer readable-instructions is referred to as an application and also for convenience all functions are described as being in the same application, application 204 of system 202. It will be appreciated that the functions may be provided in one application or may be provided across what may be called two or more applications, or in part by functionality provided by an application that is an operating system of the system 202. By way of illustration, functionality to create a modified image document with editable text within it (modified image generator 206 in FIG. 2) and a text editor (text editor 208 in FIG. 2) to edit the text of the created editable document may be provided in the same application (application 204 in FIG. 2) or across two or more applications.

In the present example, application 204 facilitates various functions related to digital documents. As mentioned these may include functions to create an editable document from an image document, the editable document editable by a text editor to edit text. The functions may also include, for example, design creation, editing, storage, organisation, searching, storage, retrieval, viewing, sharing, publishing, and/or other functions related to digital documents.

In the example of FIG. 2, system 202 is connected to a network 210. The network 210 is a communications network, such a wide area network, a local network or a combination of a one or more wide and local area networks. Via network 210 system 202 can communicate with (e.g. send data to and receive data from) other computer processing systems (not shown). The techniques described herein can, however, be implemented on a stand-alone computer system that does not require network connectivity or communication with other systems.

The system 202 may include, and typically will include, additional applications (not shown). For example, and assuming application 204 is not part of an operating system application, system 202 will include a separate operating system application (or group of applications). The system 202 may also include an application for generating or receiving image documents, which application can make the image files available to the application 204, for example by storing the image documents in memory of the system 202. For example the system 202 may include a camera application for operating a camera (such as camera 320 described below) that is part of the system 202 or in communication with the system 202.

Turning to FIG. 3, a block diagram depicting hardware component of a computer processing system 300 is provided. The system 200 of FIG. 2 may be a computer processing system 300, though alternative hardware architectures are possible.

Computer processing system 300 includes at least one processing unit 302. The processing unit 302 may be a single computer processing device (e.g. a central processing unit, graphics processing unit, or other computational device), or may include a plurality of computer processing devices. In some instances, where a computer processing system 300 is described as performing an operation or function all processing required to perform that operation or function will be performed by processing unit 302. In other instances, processing required to perform that operation or function may also be performed by remote processing devices accessible to and useable by (either in a shared or dedicated manner) system 300.

Through a communications bus 304 the processing unit 302 is in data communication with a one or more machine readable storage devices (also referred to as memory devices or just memory). Computer readable instructions and/or data (e.g. data defining documents) for execution or reading/writing operations by the processing unit 302 to control operation of the processing system 300 are stored on one more such storage devices. In this example system 300 includes a system memory 306 (e.g. a BIOS), volatile memory 308 (e.g. random access memory such as one or more DRAM modules), and non-transient or non-transitory memory 310 (e.g. one or more hard disk or solid state drives). Instructions and data may be transmitted to/received by system 300 via a data signal in a transmission channel enabled (for example) by a wired or wireless network connection over an interface such as communications interface 316.

System 300 also includes one or more interfaces, indicated generally by 312, via which system 300 interfaces with various devices and/or networks. Generally speaking, other devices may be integral with system 300, or may be separate. Where a device is separate from system 300, connection between the device and system 300 may be via wired or wireless hardware and communication protocols, and may be a direct or an indirect (e.g. networked) connection. Generally speaking, and depending on the particular system in question, devices to which system 300 connects—whether by wired or wireless means—include one or more input devices to allow data to be input into/received by system 300 and one or more output device to allow data to be output by system 300.

By way of example, system 300 may include a display 318 (which may be a touch screen display and as such operate as both an input and output device), a camera device 320, a microphone device 322 (which may be integrated with the camera device), a cursor control device 324 (e.g. a mouse, trackpad, or other cursor control device), a keyboard 326, and a speaker device 328. For example a desktop computer or laptop may include these devices. As another example, where system 300 is a portable personal computing device such as a smart phone or tablet it may include a touchscreen display 318, a camera device 320, a microphone device 322, and a speaker device 328. As another example, where system 300 is a server computing device it may be remotely operable from another computing device via a communication network. Such a server may not itself need/require further peripherals such as a display, keyboard, cursor control device and so forth, though the server may nonetheless be connectable to such devices via appropriate ports. Alternative types of computer processing systems, with additional/alternative input and output devices, are possible.

System 300 also includes one or more communications interfaces 316 for communication with a network, such as network 210 of FIG. 1. Via the communications interface(s) 316, system 300 can communicate data to and receive data from networked systems and/or devices.

In some cases part or all of a given computer-implemented method will be performed by system 300 itself, while in other cases processing may be performed by other devices in data communication with system 300.

It will be appreciated that FIG. 3 does not illustrate all functional or physical components of a computer processing system. For example, no power supply or power supply interface has been depicted, however system 300 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

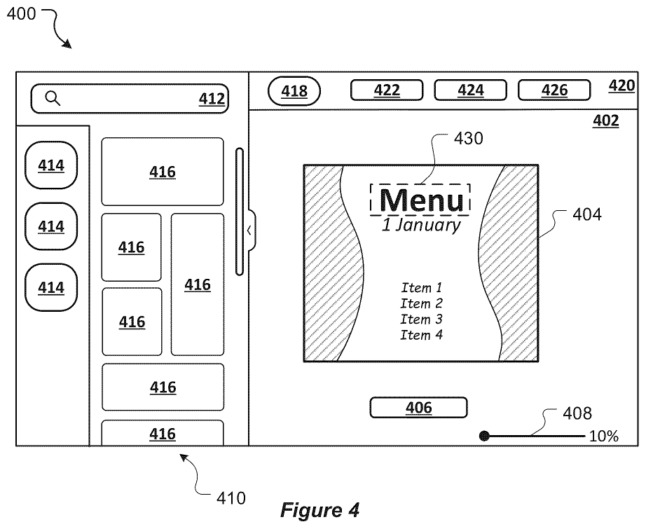

Referring to FIG. 1 and FIG. 4, application 204 configures the system 202 to provide an editor user interface 400 (UI). Generally speaking, UI 400 will allow a user to create, edit, and output documents. FIG. 4 provides a simplified and partial example of an editor UI that includes a text editor. In this example the editor UI 400 is a graphical user interface (GUI).

UI 400 includes a design preview area 402. Design preview area 402 may, for example, be used to display a page 404 (or, in some cases multiple pages) of a document. In this example, preview area 402 is being used to display a preview of design 120 of FIG. 1. The design 120 is part of a modified image document that includes editable text. The modified image document was created based on an image document including the same design 120, or a similar design to the design 120, in which the text was not editable and instead part of the image. Processes for creating such a modified image document are described elsewhere herein.

In this example an add page control 406 is provided (which, if activated by a user, causes a new page to be added to the design being created) and a zoom control 408 (which a user can interact with to zoom into/out of page currently displayed).

In some embodiments UI 400 also includes search area 410. Search area 410 may be used, for example, to search for assets that application 204 makes available to a user to assist in creating or editing designs. The asset may include one or more or existing documents. For example, an existing document may be an image document, such as a photograph. Another existing document may be a modified image document, such as a photograph but modified so that text identified in the original photograph is editable. Different types of assets may also be made available, for example design elements of various types (e.g. text elements, geometric shapes, charts, tables, and/or other types of design elements), media of various types (e.g. photos, vector graphics, shapes, videos, audio clips, and/or other media), design templates, design styles (e.g. defined sets of colours, font types, and/or other assets/asset parameters), and/or other assets that a user may use when creating or editing a document including a design.

In this example, search area 410 includes a search control 412 via which a user can submit search data (e.g. a string of characters). Search area 410 of the present example also includes several type selectors 414 which allow a user to select what they wish to search for—e.g. existing documents and/or various types of design assets that application 204 may make available for a user to assist in creating or editing a design (e.g. design templates, photographs, vector graphics, audio elements, charts, tables text styles, colour schemes, and/or other assets). When a user submits a search (e.g. by selecting a particular type via a type control 414 and entering search text via search control 412) application 204 may display previews 416 (e.g. thumbnails or the like) of any search results.

Depending on implementation, the previews 416 displayed in search area 410 (and the design assets corresponding to those previews) may be accessed from various locations. For example, the search functionality invoked by search control 412 may cause application 204 to search for existing designs and/or assets that are stored in locally accessible memory of the system 202 on which application 204 executes (e.g. non-transient or non-transitory memory such as 310 or other locally accessible memory), assets that are stored at a remote server (and accessed via a server application running thereon), and/or assets stored on other locally or remotely accessible devices.

UI 400 also includes an additional controls area 420 which, in this example, is used to display additional controls. The additional controls may include one or more: permanent controls (e.g. controls such as save, download, print, share, publish, and/or other controls that are frequently used/widely applicable and that application 204 is configured to permanently display); user configurable controls (which a user can select to add to or remove from area 420); and/or one or more adaptive controls (which application 204 may change depending, for example, on the type of design element that is currently selected/being interacted with by a user).

For example, the controls area 420 may include controls of a text editor. These controls may, for example, include controls that are utilisable by a user for changing the letters, numbers or characters of text in the design 120 or for editing the properties of the text. If the controls area 420 displays adaptive controls, these text editing controls may be displayed responsive to a text element being selected, for example user selection of a text box 430 containing text, in this case “Menu”, which was identified as part of the set of text 114. In some embodiments a cursor or similar (not shown in FIG. 4) is displayed to indicate where text that is entered by a user will be placed (e.g. using a keyboard). The cursor may be displayed, for example, responsive to user input that indicates a potential requirement to enter or change or delete text in the text box 430 (or other text in the design 120).

In some embodiments one or more of the controls in the control area 420 (or elsewhere in the UI 400) provide access to a plurality of options. For example, user selection of the control 422 may cause the display of a list of available fonts (e.g. Times New Roman, Arial, Cambria etc). Control 424 may display a list of font sizes (e.g. 8 points, 10 points, 11, points, 12 points etc). Control 426 may display a list of options (e.g. other properties such as bold, underline, strikethrough, adding shadows etc). It will be appreciated that many other options for text editing may be provided, including options that incorporate two or more property settings, for example to set a style of text as being a particular font of a particular size in bold and italics. Many such options are known from existing text editors.

The controls area 420 may include one or more controls for invoking or initiating a process for creating a modified image document with editable text, based on an original image document without editable text. In the example of FIG. 4 selection of control 418 when an image file is displayed in the design preview area 402 may cause the creation of a modified image document. The modified image document may be displayed in the design preview area 402, to enable editing, saving and other operations. In some embodiments this display of the modified image document occurs without further user input following selection of the control 418. For example, the original image document may have been an image document showing the design 110 without text boxes containing editable text and the modified image document may include text boxes and editable text, including the text box 430.

Application 204 may provide various options for outputting a design. For example, application 204 may provide a user with options to output a design by one or more of: saving a document including the design to local memory of system 202 (e.g. non-transient or non-transitory memory 310); saving the document to remotely accessible memory device; uploading the document to a server system; printing the document to a printer (local or networked); communicating the document to another user (e.g. by email, instant message, or other electronic communication channel); publishing the document to a social media platform or other service (e.g. by sending the design to a third party server system with appropriate API commands to publish the design); and/or by other output means.

Data in respect of documents including designs that have been (or are being) created or edited may be stored in various formats. An example document data format that will be used throughout this disclosure for illustrative purposes will now be described. Alternative design data formats (which make use of the same or alternative design attributes) are, however, possible, and the processing described herein can be adapted for alternative formats.

In the present context, data in respect of a particular document is stored in a document record. In the present example, the format of each document record is a device independent format comprising a set of key-value pairs (e.g. a map or dictionary). To assist with understanding, a partial example of a document record format is as follows:

| Attribute | Example |
|---|---|
| Document ID | “docId”: “abc123” |
| Dimensions | “dimensions”: {“width”: 1080, “height”: 1080} |
| Document | “name”: “Test Doc 3” |
| name | |
| Background | “background”: {“mediaID”: “M12345”} |
| Element data | “elements”: [{element 1}, . . . {element n}] |

In this example, the design-level attributes include: a document identifier (which uniquely identifies the design); dimensions (e.g. a default page or image width and height), a document name (e.g. a string defining a default or user specified name for the design), background (data indicating any page background that has been set, for example an identifier of an image that has been set as the page background) and element data defining any elements of the design. Additional and/or alternative attributes may be provided, such as attributes regarding the type of document, creation date, design version, design permissions, and/or other attributes.

In this example, the element data of a document is a set (in this example an array) of element records ({element 1} to {element n}). Each element record defines an element (or a set of grouped elements) that has been added to the page. The element record identifies the attributes of the element, including the content of the element and a position of the element. The element records may also identify the depth or z-index of the element and the orientation of the element.

Generally speaking, an element record defines an object that has been added to a page—e.g. by copying and pasting, importing from one or more asset libraries (e.g. libraries of images, animations, videos, etc.), drawing/creating using one or more design tools (e.g. a text tool, a line tool, a rectangle tool, an ellipse tool, a curve tool, a freehand tool, and/or other design tools), or by otherwise being added to a design page. In some embodiments editable text or a text box containing editable of a modified image document that has been prepared based on an original image document as described herein is defined by an element record, for example a “text” type element described below. In some embodiments an image resulting from inpainting prepared based on the original image document as described herein is also defined by an element record, for example a “shape” type element as described below.

As will be appreciated, different attributes may be relevant to different element types. By way of example, an element record for a “shape” type element (that is, an element that defines a closed path and may be used to hold an image, video, text, and/or other content) may be as follows:

| Attribute | Note | E.g. |
|---|---|---|
| Type | A value defining the type of the element. | “type”: “Shape” |
| Position | Data defining the position of the element: e.g. an (x, y) | “position”: (100, 100) |
| | coordinate pair defining (for example) the top left point | |
| | of the element. | |
| Size | Data defining the size of the element: e.g. a (width, | “size”: (500, 400) |
| | height) pair. | |
| Rotation | Data defining any rotation of the element. | “rotation”: 0 |
| Opacity | Data defining any opacity of the element (or element | “opacity”: 1 |
| | group). | |
| Path | Data defining the path of the shape the element is in | “path”: “ . . . ” |
| | respect of. This may be a vector graphic (e.g. a scalable | |
| | vector graphic) path. | |
| Media | Data indicating any media that the element holds/is used | “mediaID”: “M12345” |
| | to display. This may, for example, be an image, a video, | |
| | or other media. | |
| Content | Data defining any cropping of the media (if any) the | “mediaCrop”: { . . . } |
| crop | element holds/is used to display. | |
| Text | If the element also defines text, data defining the text | “text”: “Menu” |
| | characters | |
| Text | If the element also defines text, data defining attributes of | “attributes”: { . . . } |
| attributes | the text. | |

In the above example, the shape-type element defines a shape (e.g. a circle, rectangle, triangle, star, or any other closed shape) that can hold/display a media item. Here, the value of the “media” attribute is a “mediaID” that identifies a particular media item (e.g. an image). In other examples, the value of the media attribute may be the media data itself—e.g. raster or vector image data, or other data defining content. In this particular example, the shape-type element also displays text (the word “Menu”, which will be displayed atop the image defined by the media attribute).

As a further example, an element record for a “text” type element may be as follows:

| Key/field | Note | E.g. |
|---|---|---|
| Type | A value defining the type of the element. | “type”: “TEXT”, |
| Position | Data defining the position of the element. | “position”: (100, 100) |
| Size | Data defining the size of the element. | “size”: (500, 400) |
| Rotation | Data defining any rotation of the element. | “rotation”: 0 |
| Opacity | Data defining any opacity of the element. | “opacity”: 1 |
| Text | Data defining the actual text characters | “text”: “Menu” |
| Attributes | Data defining attributes of the text (e.g. font, font size, | “attributes”: { . . . } |
| | font style, font colour, character spacing, line spacing, | |
| | justification, and/or any other relevant attributes) | |

In the present disclosure, an element will be referred to as defining content. The content defined by an element is the actual content that the element causes to be displayed in a design—e.g. text, an image, a video, a pattern, a colour a gradient or other content. In the present examples, the content defined by an element is defined by an attribute of that element—e.g. the “media” attribute of the example “shape” type element above and the “text” attribute of the example “text” type element above.

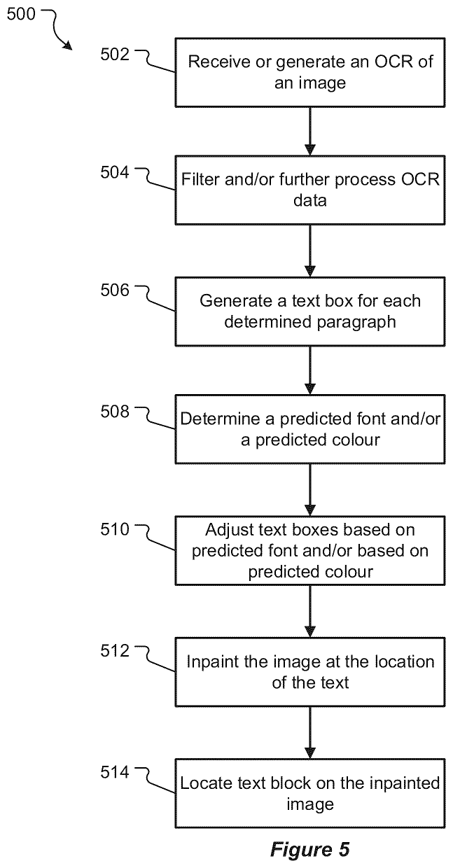

FIG. 5 depicts a computer implemented method 500 for creating an image with text editable by a text editor. The operations of method 500 will be described as being performed by application 204 running on system 202. The operations of method 500 may be performed following or responsive to selection of the control 418 of FIG. 4.

At 502, application 204 either receives or generates optical character recognition OCR data for an image document. The OCR data defines extracted text (i.e. a set of glyphs) and layout information from the image document. In one example, the OCR data is generated by a service, for example utilising the Google® OCR API. The application 204 on system 202 may request an OCR via the API. In other embodiments the system 202 provides the OCR service itself, for example in application 204 or using another application installed on the system 202. The received or generated OCR data includes character data and optionally may also include block, paragraph, word, and break information and may also include confidence information on the estimate of the text in the image.

In some embodiments the received or generated OCR data is filtered, further processed or both. The filtering and/or further processing may improve the reliability of the formation of text boxes containing text for a text editor.

The filtering may be based on the confidence information. In some embodiments, where the OCR data includes paragraph level information, then paragraph information with low confidence is filtered out of the OCR data. The filtering may be automatic, without further user input, or may be semi-automatic, with low confidence paragraphs flagged and a user input requested to indicate whether the low confidence paragraphs should be filtered out or retained.

The use of paragraph level filtering represents a good middle ground of granularity, helping to retain individual characters in an image, which typically have lower confidence scores due to the absence of context provided by adjacent letters that may be identified as a word or sentence. It also helps to filter out overly expansive paragraph definitions.

In some embodiments further processing identifies further paragraphs based on the break information in the OCR data (if any). The identification of paragraphs may be by a process of identifying break information in the OCR data, constructing words and lines using the break information, and then constructing paragraphs from the lines. The identification of paragraphs may also be performed if the generated or received OCR data does not identify paragraphs.

In some embodiments, when constructing paragraphs from the lines, some additional filtering may be applied, for example to ignore paragraphs that contain a single character that is not a digit and to ignore paragraphs if all the text is symbols. These filtering operations may assist to filter out images that are incorrectly interpreted as text, for example an image of a print of a flower head being interpreted as a star character.

In some embodiments further processing identifies further paragraphs within the blocks identified in the block information in the OCR data (if any). A single block defined by the OCR data may contain two (or more) paragraphs that are horizontally aligned with each other or contain two (or more) paragraphs that are spaced apart vertically to a large extent. In either case, paragraphs are formed by determining from the OCR data associated with the block the presence of horizontally spaced and aligned text groups or the presence vertically spaced text groups and forming paragraphs for each determined text group. For example, referring to FIG. 1B, if the OCR data identified a block encompassing all the text from “Menu” down to “Item 4”, paragraphs may be identified based on the vertical spacing between “1 January” and “Item 1”.

Other filtering operations may be performed, which filtering operations may be adapted to reflect the OCR service. For example, a service may attempt to construct words from the recognised characters and utilise that to affect the OCR data. This may result duplicate glyphs with the same character and bounding box. A filtering operation may therefore remove any duplicate glyphs with the same character and bounding box.

In some embodiments received OCR data is transformed into a standardized format. The use of a standardized format may allow different OCR services to be utilised, with the further processing transforming the OCR data from respective different formats of the OCR services to the standardized format.

Referring for example to FIG. 1A the words “It's a party” may be identified as one paragraph and the words “11 pm, #11, 111th street” and “See you there!” identified as another paragraph. Referring to FIG. 1B the words “Menu” and “1 January” may be identified as one paragraph and the words “Item 1”, “Item 2”, “Item 3 and “Item 4” identified as forming another paragraph.

At step 506, each paragraph is associated with a corresponding text box generated by the system 102, which text box contains the text of the paragraph. Each line within each paragraph is also associated with a line bounding box, defined by the OCR data. The line bounding box may be an amalgamation of the bounding boxes of each character in the OCR data. The location, size and orientation of the text box may be determined from an amalgamation of the line bounding boxes for each paragraph. The text box is editable by a text editor in the usual manner, for example to modify the text content, to move the text box, resize the text box, reorient the text box and so forth.

FIG. 1C shows a representation of the design 110 with its associated lines and paragraphs. The two paragraphs each have a respective text box 114, 116. The text box 114 includes two line bounding boxes 114A, 114B and the text box 116 includes four line bounding boxes 116A, 116B, 116C and 116D. For convenience of illustration, the text boxes 114, 116 are depicted in FIG. 1C as encompassing a larger area that the line bounding boxes that make up the text contained by the text box. The text box may however terminate at the extremities of the collection of line bounding boxes.

At step 508 at least one of a font and a colour for the text in each of the text boxes identified in step 506 is determined. The determined font is associated with the text in the text box and is a font supported by a text editor. In particular, the text editor may read data defining the determined font and render the text in that font as an output, for example as a display of the text in that font on a display screen, such as the display 318. Similarly the determined colour is associated with the text and is defined as a colour recognised and supported by the text editor.

For each line bounding box the image that was the subject of OCR in step 502 is cropped to a line image. The line image therefore includes the content of the original image within the bounds of the line bounding box.

Each line image is subject to image classification to identify a predicted or estimated font for the identified text within the line image. The image classification may be by a trained image classification model, for example a deep convolutional neural network. The training may be based on the fonts of a text editor and a training set of images containing random words in each of the supported fonts. Various image classification models and techniques for training the models are known and therefore will not be described further herein. The trained classification model may provide font predictions together with their confidences (e.g. a confidence score) and logits.

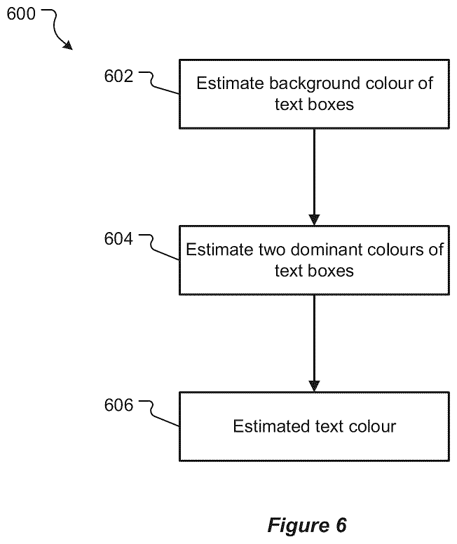

Each line image is also subject to colour analysis, to identify a predicted or estimated colour for the identified text within the line image. The colour analysis may utilise k-means clustering to identify colours and then match a predicted colour of the text to a supported colour of the text editor. An example method of colour analysis is described herein below with reference to FIG. 6.

In some embodiments the available predicted fonts and the predicted colours match the fonts and colours supported by the text editor. In these embodiments the text editor renders the text in the predicted font or the predicted colour. In other embodiments the set of predicted colours may differ from the set of fonts and colours supported by the text editor. Where a predicted font or colour is not supported by the text editor, the system may map the predicted font or colour to a supported font or colour that is associated with the predicted font or colour. The association may be by a look-up table. The association may be that the supported font or colour is the one with the least difference to the predicted font or colour.

In other embodiments, one or both of the image classification to identify a predicted or estimated font and the colour analysis is performed on with reference to a group of glyphs other than a line. For example, the image classification, the colour analysis or both may be performed on a word-by-word basis. The OCR data may include word bounding boxes or word bounding boxes may be formed based on an amalgamation of character bounding boxes for characters otherwise identified by the OCR data, or determined by the system 102, as being part of the same word. Each word may then have predicted font and/or a predicted colour.

At step 510 the predicted font, the predicted colour or both are used to further define the text boxes.

In embodiments in which the image classification and colour analysis is performed on a word-by-word basis, the word-by-word prediction is amalgamated, for example into a line prediction. For example if a line or other grouping of adjacent or near words is determined as having a majority of words of one font or colour or is determined as being predominant in one font or colour, then all words in that grouping may be set to a prediction of the majority or dominant font or colour.

Taking the example of using image classification for font prediction, the output of the image classification may identify a plurality of possible fonts, in a rank order (e.g. highest probability to lowest probability, as determined by the image classifier). Rank aggregation may then be performed on the group of words to form a single ranking, with the predicted font for the group of words, e.g. line, being the highest ranking font in the single ranking. Turning to the example of colour analysis, a central or median colour of a the colours or a group of words may be selected as the predicted colour.

In some embodiments the lines of predicted fonts, predicted colours, or both, are grouped. Similar fonts, similar colours or both are changed to be the same font or colour, for example the font or colour that is predominant.

Adjacent lines within a text box are grouped together if they have a similar colour prediction, a similar font prediction and similar height of line bounding box. Similarity of colour may be determined, for example, based on the RGB colour and Euclidean distance. Similarity of height may be with reference to a percentage change, for example within five percent or within ten percent or any other suitable threshold value. Similarity of font may be based on the highest probability classification output for one line (which may, for example be the result of rank aggregation as described above), matching the most likely or being the second-most likely (or other threshold number, such as within the top five) probability classification output for another line. Other combinations of the variables may be used to group lines, for example the predicted font and height of the line bounding box only, or the predicted colour and the height of the line bounding box only.

An estimate of font size is then made for each group of lines. The predicted font within the group that has the highest confidence is identified from the output of the image classification model. A font file for that font from a text editor is used to determine the glyph widths of each character. The glyph widths and the bounding boxes of the characters are compared to determine the estimated font size. For example, an average width of the character bounding boxes may be calculated, with the determined font being the one with a glyph width closest to the calculated average.

If a text box contains two or more groups, then separate paragraphs are identified for each group and separate text boxes are generated instead of the one text box for both groups. In particular each paragraph is associated with a corresponding text box generated by the system 102, which text box contains the text of the paragraph. For example, referring to FIG. 1B and FIG. 4, while as a result of step 506 a single text box may have contained the text “Menu” and “1 January” based on the OCR data, this single text box may be split into two based on “Menu” and “1 January” being allocated to different groups, the text box containing “Menu” being the text box 430 shown in FIG. 4.

In some embodiments the system 102 sets line lengths for use by the text editor. The line length information may be sourced from the OCR information or determined based on the OCR information. A line length defines the number of characters in a line. The system 102 sets the length of each line in a paragraph to match the line length sourced or determined from the OCR data. The line length is not confined to a maximum that matches the text box dimension. This therefore allows a line to extend outside the bounds of the text box if needed to accommodate the full line. Setting line lengths may therefore avoid unintended wrapping of text to the next line based on the font of the text editor occupying more line space than the image text.

In some embodiments the system 102 determines tracking for each paragraph and provides this information to the text editor for rendering the editable text in the text box. In typography tracking (or letter spacing) may be measured in the unit em, which is a unit of measurement relative to font size. This is calculated by measuring the total width of a line (in pixels) minus the total width of all the glyphs. This gives a total measurement of whitespace in the line, which is divided by the number of characters, to get average tracking. Finally dividing this distance by the font size gives us the tracking in EMs. The exception to this is a paragraph with justified alignment, due to uneven white space between words we look within each word in the line to calculate the tracking. This is done by measuring the distances between adjacent characters in the same word, taking an average, and again dividing by font size to give tracking in EMs.

In some embodiments the location of each text box is shifted vertically upwards. The extent of the shift is based on the font determined for the text box, to visually align the top of the text in the text box with the text in the image. In other words, this step compensates for white space in the font.

At step 512 the system 102 generates or receives (for example responsive to a request by the system 102) an inpainted image of the image received in step 502. The inpainting to form the inpainted image replaces areas of the image in which text was detected with an inpainted image. In some embodiments the inpainted image is generated by inpainting performed by an artificial intelligence (AI) image generator, called herein an “inpainting model”. The AI image generator may operate by a diffusion machine-leaning model. An example is using a masked latent diffusion model such as Stable Diffusion Inpainting, where the mask indicates the area of the text to be inpainted by the Stable Diffusion Inpainting model. Other inpainting models may be used, for example a generative adversarial network (GAN) configured for inpainting, such as large mask inpainting (LaMa), as described in Survorov et al., “Resolution-robust Large Mask Inpainting with Fourier Convolutions”, Winter Conference on Applications of Computer Vision (WACV 2022), arXiv:2109.07161.

As mentioned, the system 102 generates a mask to indicate to the inpainting model the areas to inpaint. For instance, if areas of black indicate the areas to be inpainted, then the mask may consist of black boxes or other areas that correspond to the text boxes generated in step 506, which may include any adjustments made in step 510.

In step 514 a modified image document with editable text within it is created by locating the text boxes over the inpainted image generated in step 512. The text boxes contain text with attributes based on or corresponding to the predicted font, the predicted colour, or both as determined in step 508. The editable text is editable by a text editor, for example a text editor of the system 102 or a text editor of another system. It will be appreciated that the inpainting avoids gaps in the image caused by differences between the editable text and the image text and also allows the text to be edited and relocated without creating gaps in the image where the pre-edited text.

FIG. 6 depicts a computer implemented method 600 for predicting or estimating a font colour for identified text in an OCR image. The computer implemented method 600 may be performed to implement, in part, step 508 of the computer implemented method 500.

In step 602, for each text box for which inpainting is to be performed, for example all text boxes identified at the completion of step 510 of the computer implemented method 500, an estimate of a background colour of the image for each text box is determined. The estimate of the background colour may be with reference to a background prediction zone. The background prediction zone is one that is expected to not contain portions of the image corresponding to the detected text.

The background prediction zone may therefore be defined as an area of the image at or around the edges of the text box. In some embodiments the area of the background prediction zone includes a buffer for the text box, for example a buffer of 5 pixels around the text box. The addition of a buffer may be contingent on the buffer not extending beyond the bounds of the image. For example if an identified text box for an image is within 2 pixels of the edge of the image, then the buffer is reduced from 5 pixels to 2 pixels along the edge of the text box adjacent that edge of the image. In some embodiments the prediction zone may be expanded to include some of the interior of the text box. For example, the buffer may be 5 pixels extending from the edges of a text box and also include 3 pixels inwards from the text box along at least a portion of at least one side (up to all portions of all sides), so that the prediction zone is 8 pixels in width, subject to not extending outside of the bounds of the image. More or less of the image (e.g. down to 1 pixel in width) may be defined as a prediction zone, which may be formed by a contiguous area or a plurality of non-contiguous areas. In some embodiments the dominant colour of the background prediction zone is determined by applying to the background prediction zone k-means clustering with 1 cluster.

In step 604 an estimate of two dominant colours is determined for a dominant colour prediction zone of the image corresponding to each of the text boxes. Unlike step 602 the dominant colour prediction zone includes areas of the image within the text box that are expected to contain portions of the image corresponding to the detected text. In some embodiments the dominant colour prediction zone includes the entirety of the area of the image corresponding to the area occupied by the text box. The dominant colour prediction zone also includes at least part of the background prediction zone. In some embodiments the dominant colour prediction zone includes all of the background prediction zone. The two dominant colours of the dominant colour prediction zone may be estimated by applying k-means clustering with 2 clusters. The two dominant colours may be ordered based on the area of the image they occupy, for example determined by a pixel count. A most dominant colour corresponds to the colour of the two dominant colours that has the highest pixel count and a second-most dominant colour corresponds to the other of the two dominant colours.

In step 606 an estimated text colour is determined, based on the estimated background colour and the estimated two dominant colours. The most dominant colour is compared to the estimated background colour. If the most dominant colour is not similar to the estimated background colour, then the predicted text colour is determined as the most dominant colour. If the most dominant colour is similar to the estimated background colour, then the predicted text colour is determined as the second-most dominant colour. The comparison may be by a Euclidean distanced based similarity algorithm on the RGB colours. In some embodiments a similarity threshold of 0.75 is used to determine whether or not the most dominant colour is similar to the estimated background colour.

Additional aspects of the present disclosure are described in the following clauses:
Clause A1. A computer implemented method including:
   for image data defining a first image and associated text data, the associated text data including optical character recognition (OCR) data formed based on the first image:
      determining, based on the first image, at least one of a predicted colour and a predicted font of text defined by the OCR data; and
      forming, based on the OCR data and the at least one of a predicted colour and a predicted font, at least one text box, each text box comprising the text defined by the OCR data and having attributes including:
         a text colour that is or is associated with the predicted colour, or
         a text font that is or is associated with the predicted font, or
         a text colour that is or is associated with the predicted colour and a text font that is or is associated with the predicted font;
      forming a second image based on the first image by inpainting the first image, including inpainting an area of the first image corresponding to said text defined by the OCR data; and
      locating the at least one text box on the second image.
Clause A2. The computer implemented method of clause A1, wherein locating the at least one text box on the second image is location at or near a location of the text defined by the OCR data.
Clause A3. The computer implemented method of clause A1 or clause A2, including determining, based on a portion of the first image including the text defined by the OCR data, a predicted colour of the text, wherein the determining of the predicted colour is by k-means clustering applied to the portion of the first image.
Clause A4. The computer implemented method of clause A3, wherein applying the k-means clustering includes determining two dominant colours within the portion of the first image and determining one of the dominant colours as the predicted colour.
Clause A5. The computer implemented method of any one of clauses A1 to A4, including determining, based on a portion of the first image, a predicted font of the text, wherein the determining of the predicted font is by applying a trained image classification model to the portion of the first image.
Clause A6. The computer implemented method of clause A5, wherein the trained image classification model is a model trained based to classify images into classes comprising a plurality of fonts of a text editor operable to edit the at least one text box.
Clause A7. The computer implemented method of any one of clauses A1 to A6, including determining a predicted font size based on the first image, wherein the text in a said text box is text with a font size matching the predicted font size.
Clause A8. The computer implemented method of any one of clauses A1 to A7, further including determining a line length for each of a plurality of lines of a said text box based on the OCR data, wherein the text box is formed with line lengths corresponding to the determined line lengths.
Clause A9. The computer implemented method of clause A8, wherein the determined line length for at least one line is a length greater than what can be accommodated within the text box.
Clause A10. The computer implemented method of any one of clauses A1 to A9, wherein locating the at least one text box on the second image includes determining a vertical position for at least one of the text boxes based on the text font for that text box.
Clause A11. The computer implemented method of any one of clauses A1 to A10, further including providing a text editor and responsive to user input for the text editor, editing the text of the first editable text box, wherein the text editor supports a plurality of fonts and wherein the text font is supported by the text editor.
Clause A12. The computer implemented method of any one of clauses A1 to A11, including determining, based on the first image, both of a predicted colour and a predicted font of the text defined by the OCR data, wherein the at least one text box is formed based on both the predicted colour and the predicted font.
Clause A13. A computer implemented method including:
   for image data defining a first image and associated text data, the associated text data including optical character recognition (OCR) data defining a plurality of glyphs in the first image and data defining a first bounding box for a group of glyphs within the plurality of glyphs, wherein the first bounding box is one of one or more bounding boxes for groups of glyphs within the plurality of glyphs:
      determining, based on a portion of the first image within the first bounding box, at least one of a predicted colour and a predicted font of the at least one group of glyphs; and
      forming, based on the OCR data and the at least one of a predicted colour and a predicted font, at least one text box for the first bounding box, each text box comprising text defined by the group of glyphs, the text having attributes including:
         a text colour that is or is associated with the predicted colour, or
         a text font that is or is associated with the predicted font, or
         a text colour that is or is associated with the predicted colour and a text font that is or is associated with the predicted font;
      forming a second image based on the first image by inpainting the first image, including inpainting an area of the first image corresponding to the first bounding box;
      locating the at least one text box on the second image.
Clause A14. The computer implemented method of clause A13, wherein locating the at least one text box on the second image is location at or near a location of the first bounding box.
Clause A15. The computer implemented method of clause A13 or clause A14, including determining, based on a portion of the first image within the first bounding box, a predicted colour of the at least one group of glyphs, wherein the determining of the predicted colour is by k-means clustering applied to the portion of the first image.
Clause A16. The computer implemented method of clause A15, wherein applying the k-means clustering includes determining two dominant colours within the portion of the first image and determining one of the dominant colours as the predicted colour.
Clause A17. The computer implemented method of any one of clauses A13 to A16, including determining, based on a portion of the first image within the first bounding box, a predicted font of the at least one group of glyphs, wherein the determining of the predicted font is by applying a trained image classification model to the portion of the first image.
Clause A18. The computer implemented method of clause A17, wherein the trained image classification model is a model trained based to classify images into classes comprising a plurality of fonts of a text editor operable to edit the at least one text box.
Clause A19. The computer implemented method of any one of clauses A13 to A18, wherein the at least one group of glyphs is at least a group of glyphs determined to be words based on the OCR data or at least one group of glyphs determined to be lines based on the OCR data.
Clause A20. The computer implemented method of any one of clauses A13 to A19, wherein the at least one group of glyphs comprises a plurality of groups of glyphs and wherein the method includes grouping two or more of the plurality of groups of glyphs into a single group, based on a similarity of at least one of the predicted colour and the predicted font for each of the two or more of the plurality of groups of glyphs.
Clause A21. The computer implemented method of any one of clauses A13 to A20, including determining, based on the portion of the first image within the first bounding box, a predicted font, wherein the predicted font includes a predicted font size, wherein the text in a said text box is text with a font size matching the predicted font size.
Clause A22. The computer implemented method of any one of clauses A13 to A21, further including determining a line length for each of a plurality of lines of a said text box based on the OCR data, wherein the text box is formed with line lengths corresponding to the determined line lengths.
Clause A23. The computer implemented method of clause A22, wherein the determined line length for at least one line is a length greater than what can be accommodated within the text box.
Clause A24. The computer implemented method of any one of clauses A13 to A23, wherein locating the at least one text box on the second image includes determining a vertical position for at least one of the text boxes based on the text font for that text box.
Clause A25. The computer implemented method of clause A24, wherein the vertical position is determined to visually align the top of the text in the text box with the plurality of glyphs in the first image.
Clause A26. The computer implemented method of any one of clauses A13 to A25, further including providing a text editor and responsive to user input for the text editor, editing the text of the first editable text box, wherein the text editor supports a plurality of fonts and wherein the text font is supported by the text editor.
Clause A27. The computer implemented method of any one of clauses A13 to A26, including determining, based on the portion of the first image within the first bounding box, both of a predicted colour and a predicted font of the at least one group of glyphs, wherein the at least one text box is formed based on both the predicted colour and the predicted font.
Clause A28. A computer implemented method including:
   for image data defining a first image and associated text data, the associated text data including optical character recognition (OCR) data defining a plurality of glyphs in the first image and data defining a plurality of bounding boxes containing distinct groups of glyphs of the plurality of glyphs, wherein the plurality of bounding boxes consists of or includes a first bounding box, a second bounding box and a third bounding box:
      determining a likely font for the plurality of glyphs in each of the first, second and third bounding boxes, the determining including applying to the image data an image classification model trained to identify at least one likely font of a plurality of glyphs in an image, from a plurality of predefined fonts; and
      forming a first editable text box based on the OCR data, the first editable text box including text corresponding to the plurality of glyphs contained in the first bounding box and the second bounding box, but not the third bounding box, based at least in part on determinations that a) the determined likely font of the first and second bounding boxes is the same and b) the determined likely font of the first and second bounding boxes is different to the determined likely font of the third bounding box, wherein the text of the first editable text box is in the determined likely font of the first and second bounding boxes or in a font associated with the determined likely font of the first and second bounding boxes.
Clause A29. The computer implemented method of clause A28, further including receiving user input via a user interface provided by a text editor, and responsive to the user input editing the text of the first editable text box, wherein the text editor supports a plurality of fonts and wherein the image classification model was trained to identify which of the plurality of fonts most closely matches text in an image.
Clause A30. The computer implemented method of clause A28 or clause A29, wherein the determination that the determined likely font of the first and second bounding boxes is the same is based on a determined likely colour for the plurality of glyphs in the first and second bounding boxes is the same or similar.
Clause A31. A computer implemented method including:
   for image data defining a first image and associated text data, the associated text data including optical character recognition (OCR) data defining a plurality of glyphs in the first image and data defining a plurality of bounding boxes containing distinct groups of glyphs of the plurality of glyphs, wherein the plurality of bounding boxes consists of or includes a first bounding box, a second bounding box and a third bounding box:
      determining a likely colour for the plurality of glyphs in each of the first, second and third bounding boxes, wherein the likely colour is determined as a first or second most dominant colour of the first image within the respective bounding box; and
      forming a first editable text box based on the OCR data, the first editable text box including text corresponding to the plurality of glyphs contained in the first bounding box and the second bounding box, but not the third bounding box, based at least in part on a determination that a) the determined likely colour for the first and second bounding boxes is the same and b) the determined likely colour for the first and second bounding boxes is different to the determined likely colour for the third bounding box, wherein the editable text is in a text colour that is or is associated with the determined likely colour of the first and second bounding boxes.
Clause A32. The computer implemented method of clause A31, further including receiving user input via a user interface provided by a text editor, and responsive to the user input editing the text of the first editable text box to a colour different to the text colour.
Clause A33. A computer processing system including:
   a processing unit; and
   a non-transient or non-transitory computer-readable storage medium storing instructions, which when executed by the processing unit, cause the processing unit to perform a method according to any one of clauses A1 to A32.
Clause A34. The computer processing system of clause A33, wherein the non-transient or non-transitory computer-readable storage medium further stores instructions to implement a text editor, wherein the text editor is configured to allow a user of the computer processing system to edit each said text box.
Clause A35. The computer processing system of clause A34, wherein the text editor has a set of predefined fonts and wherein the editing of each said text box includes changing the font of the text within the text box.
Clause A36. The computer processing system of clause A34 or clause A35, wherein the text editor has a set of colours for text and wherein the editing of each said text box includes changing the colour of the text within the text box.
Clause A37. The computer processing system of any one of clauses A34 to A36, wherein the text editor is configured to change the location of the text box.
Clause A38. A non-transient or non-transitory storage medium storing instructions executable by processing unit to cause the processing unit to perform a method according to any one of clauses A1 to A32.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

Throughout this specification references are made to boxes, including in particular bounding boxes and text boxes. This is not intended to require that the bounding boxes or text boxes be rectangular or square, although a bounding box or text box may be rectangular or square and in many instances will be. A bounding box could however form another shape, such as a curvilinear shape or be piecewise and a text box corresponding to that bounding box may be of the same or a similar shape.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

In some instances the present disclosure may use the terms “first,” “second,” etc. to identify and distinguish between elements or features. When used in this way, these terms are not used in an ordinal sense and are not intended to imply any particular order. For example, a first user input could be termed a second user input or vice versa without departing from the scope of the described examples. Furthermore, when used to differentiate elements or features, a second user input could exist without a first user input or a second user input could occur before a first user input.

Background information described in this specification is background information known to the inventors. Reference to this information as background information is not an acknowledgment or suggestion that this background information is prior art or is common general knowledge to a person of ordinary skill in the art.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method including:
for image data defining a first image and associated text data, the associated text data including optical character recognition (OCR) data formed based on the first image:
determining, based on the first image, at least one of a predicted colour and a predicted font of text defined by the OCR data; and
forming, based on the OCR data and the at least one of a predicted colour and a predicted font, at least one text box, each text box comprising the text defined by the OCR data and having attributes including:
a text colour that is or is associated with the predicted colour, or
a text font that is or is associated with the predicted font, or
a text colour that is or is associated with the predicted colour and a text font that is or is associated with the predicted font;
forming a second image based on the first image by inpainting the first image, including inpainting an area of the first image corresponding to said text defined by the OCR data; and
locating the at least one text box on the second image.

2. The computer implemented method of claim 1, wherein locating the at least one text box on the second image is location at or near a location of the text defined by the OCR data.

3. The computer implemented method of claim 1, including determining, based on a portion of the first image including the text defined by the OCR data, a predicted colour of the text, wherein the determining of the predicted colour is by k-means clustering applied to the portion of the first image.

4. The computer implemented method of claim 3, wherein applying the k-means clustering includes determining two dominant colours within the portion of the first image and determining one of the dominant colours as the predicted colour.

5. The computer implemented method of claim 1, including determining, based on a portion of the first image, a predicted font of the text, wherein the determining of the predicted font is by applying a trained image classification model to the portion of the first image.

6. The computer implemented method of claim 5, wherein the trained image classification model is a model trained based to classify images into classes comprising a plurality of fonts of a text editor operable to edit the at least one text box.

7. The computer implemented method of claim 1, including determining a predicted font size based on the first image, wherein the text in a said text box is text with a font size matching the predicted font size.

8. The computer implemented method of claim 1, further including determining a line length for each of a plurality of lines of a said text box based on the OCR data, wherein the text box is formed with line lengths corresponding to the determined line lengths.

9. The computer implemented method of claim 8, wherein the determined line length for at least one line is a length greater than what can be accommodated within the text box.

10. The computer implemented method of claim 1, wherein locating the at least one text box on the second image includes determining a vertical position for at least one of the text boxes based on the text font for that text box.

11. The computer implemented method of claim 1, further including providing a text editor and responsive to user input for the text editor, editing the text of the first editable text box, wherein the text editor supports a plurality of fonts and wherein the text font is supported by the text editor.

12. The computer implemented method of claim 1, including determining, based on the first image, both of a predicted colour and a predicted font of the text defined by the OCR data, wherein the at least one text box is formed based on both the predicted colour and the predicted font.

13. A computer processing system including:
a processing unit; and
a non-transitory computer-readable storage medium storing instructions, which when executed by the processing unit, cause the processing unit to perform a method including:
for image data defining a first image and associated text data, the associated text data including optical character recognition (OCR) data formed based on the first image:
determining, based on the first image, at least one of a predicted colour and a predicted font of text defined by the OCR data; and
forming, based on the OCR data and the at least one of a predicted colour and a predicted font, at least one text box, each text box comprising the text defined by the OCR data and having attributes including:
a text colour that is or is associated with the predicted colour, or
a text font that is or is associated with the predicted font, or
a text colour that is or is associated with the predicted colour and a text font that is or is associated with the predicted font;
forming a second image based on the first image by inpainting the first image, including inpainting an area of the first image corresponding to said text defined by the OCR data; and
locating the at least one text box on the second image.

14. The computer processing system of claim 13, wherein the non-transitory computer-readable storage medium further stores instructions to implement a text editor, wherein the text editor is configured to allow a user of the computer processing system to edit each said text box.

15. The computer processing system of claim 14, wherein the text editor has a set of predefined fonts and wherein the editing of each said text box includes changing the font of the text within the text box.

16. The computer processing system of claim 14, wherein the text editor has a set of colours for text and wherein the editing of each said text box includes changing the colour of the text within the text box.

17. The computer processing system of claim 14, wherein the text editor is configured to change the location of the text box.

18. A non-transitory storage medium storing instructions executable by processing unit to cause the processing unit to perform a method including:
for image data defining a first image and associated text data, the associated text data including optical character recognition (OCR) data formed based on the first image:
determining, based on the first image, at least one of a predicted colour and a predicted font of text defined by the OCR data; and
forming, based on the OCR data and the at least one of a predicted colour and a predicted font, at least one text box, each text box comprising the text defined by the OCR data and having attributes including:
a text colour that is or is associated with the predicted colour, or
a text font that is or is associated with the predicted font, or
a text colour that is or is associated with the predicted colour and a text font that is or is associated with the predicted font;
forming a second image based on the first image by inpainting the first image, including inpainting an area of the first image corresponding to said text defined by the OCR data; and
locating the at least one text box on the second image.
